(19) United States
(12) Patent Application Publication
(10) Pub. No.: US 2025/0069501 A1
(43) Pub. Date: Feb. 27, 2025

(54) BATTERY-POWERED VEHICLE DETECTING DEVICE USING AN EMBEDDED INDUCTIVE SENSOR

(71) Applicant: Nwave Technologies Inc, Sacramento, CA (US)

(72) Inventor: Yury BIRCHENKO, London (GB)

(21) Appl. No.: 18/941,465

(22) Filed: Nov. 8, 2024

Related U.S. Application Data
(63) Continuation-in-part of application No. 17/752,406, filed on May 24, 2022.
(60) Provisional application No. 63/196,085, filed on Jun. 2, 2021.

(51) Int. Cl. G08G 1/042; G01J 1/42; G08G 1/04; H04W 4/38

(52) U.S. Cl. CPC G08G 1/042; G01J 1/4204; G08G 1/04; H04W 4/38

(57) ABSTRACT

Embodiments of the present invention provide battery-powered, wireless, vehicle-detection devices that use one or more inductive sensors to detect vehicles. The inductive sensors can have different sized loop-coils that provide different sensitivities for detecting near conductive objects and far conductive objects. The battery-powered, wireless, detection devices can regulate the use of the power-hungry inductive sensors to preserve battery power. Some embodiments include low-power sensors such as light detectors and magnetometers to detect a possible vehicle before powering on/activating inductive sensors.

### CROSS-REFERENCE TO RELATED APPLICATIONS

This application is a continuation-in-part of and claims the priority benefit of U.S. Patent Application titled, “BATTERY-POWERED VEHICLE DETECTION DEVICE USING AN EMBEDDED INDUCTIVE SENSOR,” having Ser. No. 17/752,406 and filed on May 24, 2022, which claims the priority benefit of U.S. Provisional Patent Application titled, “BATTERY-POWERED VEHICLE DETECTION DEVICE USING AN EMBEDDED INDUCTIVE SENSOR,” filed on Jun. 2, 2021, having Application Ser. No. 63/196,085. The subject matter of these related applications is hereby incorporated herein by reference.

### TECHNICAL FIELD

Embodiments of the present invention generally relate to the field of vehicle sensors. More specifically, embodiments of the present invention relate to battery-powered, wireless vehicle-detection devices.

### BACKGROUND

A battery-powered vehicle-detection device that detects the presence of a motor vehicle is typically relatively small, easy to carry, and easy to install. These devices are often used to monitor parking spaces and count vehicles within an area. The battery-powered vehicle-detection device communicates with a parking or traffic management system using a wireless protocol. The battery-powered vehicle-detection device typically receives its power from one or more small, long-lasting batteries.

FIG. 1 depicts a prior-art battery-powered wireless vehicle-detection device as described in US Patent Application No. 20190311622. The vehicle-detection device body 150 houses and supports a circular shaped PCB 120 and the batteries 130. The vehicle-detection device base 160 supports the vehicle-detection device body 150. A central, vertical pillar 110 connects to the vehicle-detection device base 160 and is capable of supporting the weight of a motor vehicle. The rubber O-ring 140 provides a hermetic seal to prevent moisture from entering the device. The circular PCB 120 includes electronics for motor vehicle sensing and wireless communication (e.g., Bluetooth, LoRaWAN, etc.) The batteries 130 can be disposed around the outside of the circular PCB 120 at approximately the same vertical elevation to minimize the height of the vehicle-detection device 100.

US Patent Application No. 20200053563 describes electronic devices for motor vehicle sensing. The vehicle-detection capabilities include a magnetometer to detect ferrous metals, an IR sensor to detect reflected LED pulses, an active ultrasonic sensor based on time-of-flight principle, vibration and other sensors.

As the automotive industry transitions from gasoline powered vehicle to electric vehicles, the vehicles contain less and less ferrous metals and the magnetometer becomes less and less accurate as a vehicle sensor. Pollution, snow, ice and water change the reflective properties of the vehicle bottom and road surface. These conditions can interfere with the operation of sensors that detect light or electromagnetic waves.

What is needed is a battery-powered vehicle-detection devices with improved sensing capabilities that supports both next-generation vehicles and changing environmental conditions.

### BRIEF DESCRIPTION OF THE DRAWINGS

The accompanying drawings, which are incorporated in and form a part of this specification and in which like numerals depict like elements, illustrate embodiments of the present disclosure and, together with the description, serve to explain the principles of the disclosure.

FIG. 1 depicts an exemplary prior-art battery-powered, wireless vehicle-detection device.

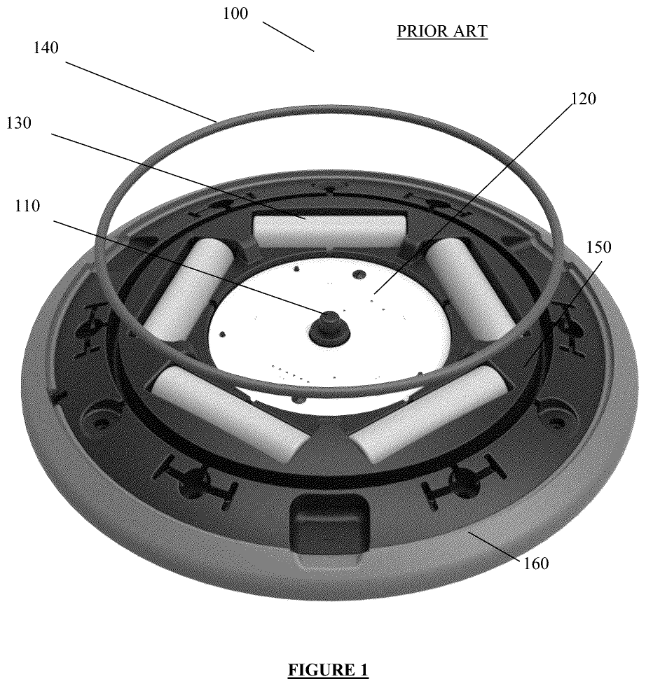

FIG. 2 is a diagram showing an exemplary system employing a vehicle-detection device according to embodiments of the present invention.

FIG. 3 is a diagram depicting a top view of an exemplary printed circuit board with sensing components according to embodiments of the present invention.

FIG. 4 is a conceptual diagram depicting exemplary connectivity of the printed circuit board components according to embodiments of the present invention.

FIG. 5 is an exemplary diagram depicting batteries embedded within cut-out areas of the printed circuit board according to embodiments of the present invention.

FIG. 6 is a flow chart that illustrates an exemplary method for controlling high-power sensors according to embodiments of the present invention.

FIG. 7 is a block diagram of a battery-powered wireless vehicle-detection device, according to an embodiment of the present invention.

FIG. 8 is a perspective view of an exemplary vehicle detection device having a central pillar, casing, batteries and printed circuit board.

### DETAILED DESCRIPTION

Reference will now be made in detail to several embodiments. While the subject matter will be described in conjunction with the alternative embodiments, it will be understood that they are not intended to limit the claimed subject matter to these embodiments. On the contrary, the claimed subject matter is intended to cover alternative, modifications, and equivalents, which may be included within the spirit and scope of the claimed subject matter as defined by the appended claims.

Furthermore, in the following detailed description, numerous specific details are set forth in order to provide a thorough understanding of the claimed subject matter. However, it will be recognized by one skilled in the art that embodiments may be practiced without these specific details or with equivalents thereof. In other instances, well-known methods, procedures, components, and circuits have not been described in detail as not to unnecessarily obscure aspects and features of the subject matter. It should be borne in mind, however, that all of these and similar terms are to be associated with the appropriate physical quantities and are merely convenient labels applied to these quantities. Unless specifically stated otherwise as apparent from the following discussions, it is appreciated that throughout, discussions utilizing terms such as “accessing,” “displaying,” “writing,” “including,” “storing,” “transmitting,” “traversing,” “determining,” “identifying,” “observing,” “adjusting,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

### Battery-Powered Vehicle-Detection Device with Inductive Sensor

An inductive sensor uses the principle of electromagnetic induction to detect or measure objects. An inductor develops a magnetic field when a current flows through it. An external conductive object placed in proximity changes the magnetic field created by inductor and hence changes its measured inductance (e.g., the ratio between the magnetic field flux and the current). Inductive sensors work well within harsh environments as they are generally robust and can deliver stable signals even in hostile environments. Many entities monitor traffic by embedding large inductance loops or coils of wire in the road surface. The inductance loop/coil is typically connected to an alternating current power supply to create an inductive sensor. When a vehicle approaches the inductance loop/coil, the loop's/coil's inductance changes due to the presence of conductive vehicle components in the induced magnetic field. The sensor circuit measures or detects that change of inductance.

Embodiments of the present invention include devices having inductance loops/coils and inductive sensors embedded in a small, battery-powered device, which presents several challenges. The sensing range is dependent on the coil diameter and coil diameters are usually much larger than that of a battery-powered vehicle-detection device. The detection sensitivity declines rapidly with distances beyond a one coil diameter. Battery-powered vehicle-detection devices have batteries with limited power that provide direct current. Inductive sensors require high power and require alternating current.

The battery-powered vehicle-detection device with an inductive sensor (BVDI) employs an inductive coil located around and close to the outer perimeter of a circular printed circuit board (PCB). The detection range depends on the diameter of a loop so that the coil diameter needs to be maximized within the limitation of the overall device physical size. The BVDI enables the inductive sensor for short periods of time to conserve power and relies on conventional low-power sensors most of the time. In one embodiment, the inductive sensor employs a wide range 28-bit analog to digital converter chip to measure the alternating current frequency and obtain the required inductance measurement accuracy beyond two loop diameters. For example, a truck with a clearance of 15″ may be detected by a coil of just 4″ in diameter. Other embodiments comprise a loop coil having a diameter of at least 4 cm and a sensing range of at least 12 cm.

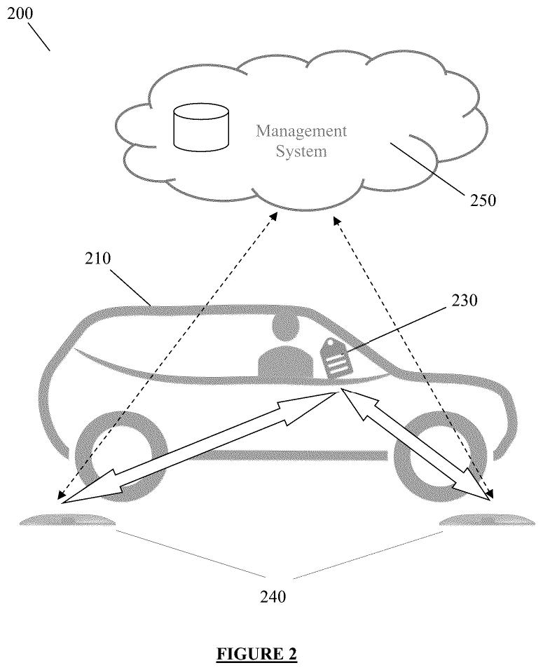

FIG. 2 is a diagram 200 showing an exemplary vehicle-detection system according to embodiments of the present invention. The vehicle 210 contains a communication device 230 such as a smart-phone or a vehicle's embedded computer. Battery-powered vehicle-detection device devices 240 detect vehicle 210 and communicate with the communication device 230 using Bluetooth. The battery-powered vehicle-detection device devices 240 have long-range wireless communication capability and communicate with a remote management server 250. Other possible remote systems include a portable device, a vehicle counting system and an automatic gate control system.

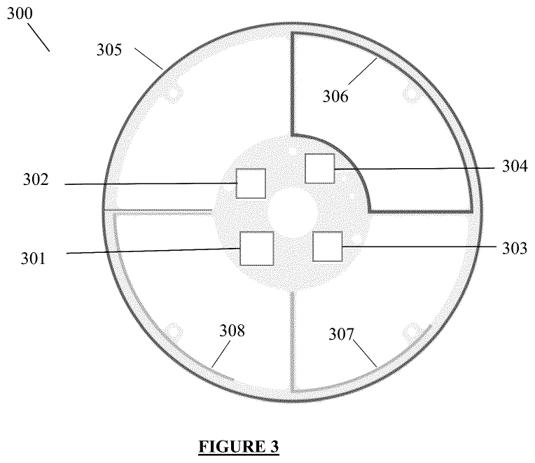

FIG. 3 is a diagram depicting a top view of an exemplary printed circuit board (PCB) 300 with sensing components according to embodiments of the present invention. This embodiment describes two passive, low-power sensors and one high-power inductive sensor. A microprocessor 301 provides overall BVDI control. Microprocessor 301 orchestrates all sensing tasks and handles RF communication. A magnetometer 302 detects ferrous metals. Magnetometer 302 acts as a passive, low-power sensor that can be used for initial detection. An ambient light sensor 303 detects variations in the ambient light level. The ambient light sensor 303 also acts as a passive, low-power sensor that can be used for initial detection. The Inductance Management and Digital Converter Unit (IMDCU) 304 controls the power input to two loop coil inductors 305 and 306, converts the DC battery current to AC for the coils, and measures inductive current. Together parts 304, 305, 306 represent the inductive sensor.

In the example of FIG. 3, the larger inductance coil 305 has multiple turns around the outer rim of the PCB 300. According to some embodiments, the larger inductance coil 305 has ten turns. According to other embodiments, the larger inductance coil 305 could have one turn.

The smaller inductance coil 306 has a smaller effective diameter, has limited sensitivity to vehicles on top and acts mainly as a reference to help offset environment changes to inductance, e.g. temperature, humidity, etc. In contrast, the larger inductance coil 305 has a larger effective diameter and is better for detecting vehicles at a range above 5 inches. Different embodiments of the smaller inductance coil could have different numbers of turns. In the example of FIG. 3, the smaller inductance coil 306 is located around a quadrant of the PCB 300. RF antenna 307 acts a Bluetooth antenna for short to medium distance communication. RF antenna 308 acts an antenna for long-distance communication, typical at a sub-GHz wavelength.

Different BVDI embodiments could have one or more inductive sensors, one or more passive low-power sensors, and different types of low-power sensors. A battery-powered vehicle-detection device could use many combinations of sensors with or without an inductive sensor. Sensor examples include radar and passive light detection sensors.

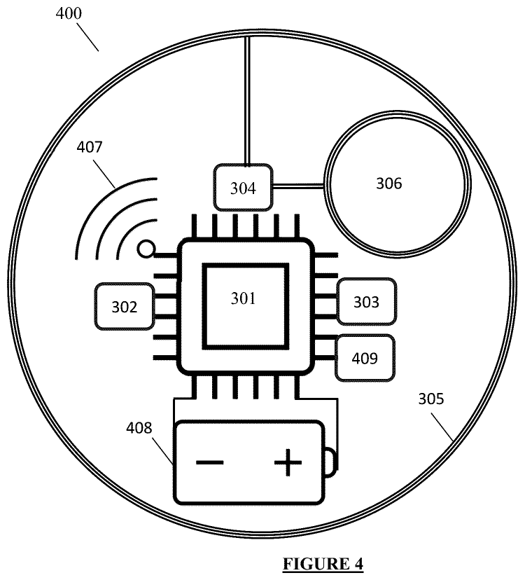

FIG. 4 is a diagram depicting an exemplary vehicle detection device 400 including printed circuit board components according to embodiments of the present invention. The microprocessor 301 connects to memory 409, the magnetometer 302, ambient light sensor 303, the Inductance Management and Digital Converter Unit 304, radio transmission system 407, and the battery 408. According to some embodiments, the memory 409 and microprocessor 301 are integrated within the same silicon device or within the same semiconductor package. The microprocessor 301 reads from and writes to the memory 409. Memory 409 holds executable instructions and status information updated by microprocessor 301. The microprocessor 301 controls the magnetometer 302, and ambient light sensor 303 by initiating their operation and reading vehicle-detection measurements from them. The microprocessor 301 controls the Inductance Management and Digital Converter Unit 304 by enabling the inductive sensors at certain times and taking measurements from them. The microprocessor 301 controls the radio transmission system 407, sending and receiving messages over Bluetooth and the long-distance radio. Battery 408 supplies power to the PCB and all components.

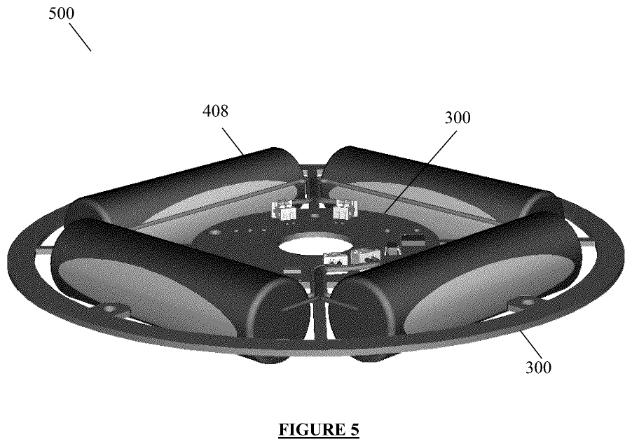

FIG. 5 is a diagram of an exemplary device 500 including batteries 408 embedded within cut-out areas (or pre-fabricated holes) of the printed circuit board 300 according to embodiments of the present invention. Locating the batteries 408 within the plane of printed circuit board 300 minimizes the BVDI height. Locating the batteries 408 inside printed circuit board 300 maximizes the diameter of inductance coil 305 while optimizing the overall device diameter.

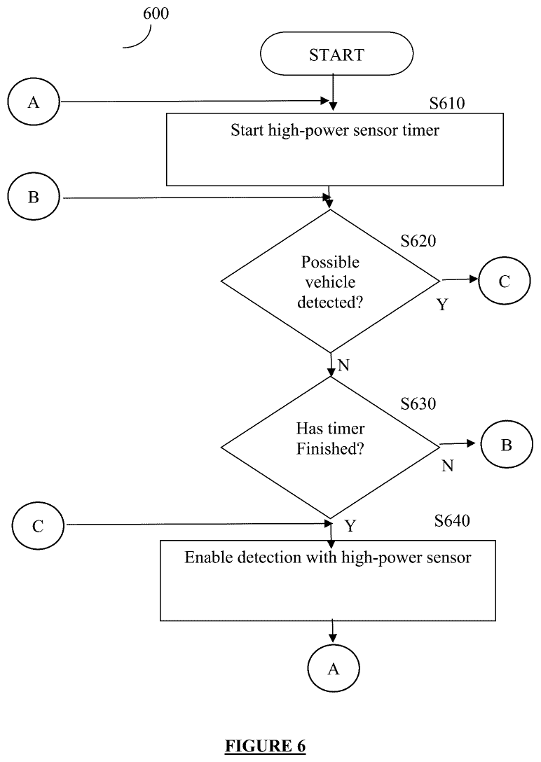

FIG. 6 is a flow diagram 600 that illustrates an exemplary method for controlling high-power sensors according to embodiments of the present invention. At step 610 the BVDI starts a high-power sensor timer. At step 620 the BVDI checks to see if any of the low-power sensors have detected a possible vehicle. If the BVDI finds that any sensors have detected a possible vehicle it proceeds to step 640. If the BVDI does not find a sensor detecting a possible vehicle it continues to step 630. At step 630 the BVDI checks if the timer has expired.

If the timer has expired the BVDI proceeds to step 640. If the timer has not expired the BVDI returns to step 620. At step 640 the BVDI enables the high-power sensors and takes vehicle-detection measurements. According to some embodiments, the BVDI enables the high-power sensors separately, one after another. After taking high-power sensor measurements the BVDI jumps back to step 610.

The low-power sensors may operate persistently or use their own shorter duration timers.

The BVDI can be configured so that each high-power sensor has a different timer with a different duration. In this configuration, the BVDI uses the method of FIG. 6 on each high-power sensor separately and in parallel. At step 640 the BVDI enables the specific high-power sensor whose timer has expired.

The BVDI can also be configured to apply different methods for first detecting a vehicle and for subsequently detecting the absence of a vehicle. A vehicle can be parked close to the BVDI for many hours and the magnetometer or light measurements may be sufficient to confirm that the vehicle is still there. In this case, the BVDI has no need to take inductive sensor measurements.

To keep track of the base level of the signal (with no car) and to adjust for gradual changes due to temperature drifts, precipitation, etc. the inductive sensors can be turned on for a brief measurement, such as 25 milliseconds approximately every minute. Passive sensor data can be sampled at intervals varying between 100 milliseconds and 20 seconds to detect changes indicating an increased probability of vehicle presence. When the estimated probability function is above a certain threshold the control processor can turn on inductive sensing.

Both inductive coils are susceptible to common thermal drifts or other near range changes (less than one coil diameter). In some embodiments the high-power inductive sensor timer duration can vary, for example, based on onboard passive sensor measurements.

Larger coils have a proportionally longer sensing range and are much more responsive to environment changes beyond one diameter of a smaller coil. Statistical regression algorithms are applied on time series data from both inductive sensors to detect a useful signal induced by objects beyond one diameter of a smaller coil.

To further the objective of obtaining high-sensitivity and high-accuracy inductive measurements, wherein a battery operated device of relatively compact size is used to detect a vehicle at a separation height beyond two coil diameters, further details are described relating to (i) power minimization by increasing the frequency of measurement; (ii) desensitizing inductive measurements to temperature changes by deploying a stable oscillator to clock the AC signal; and (iii) deploying a combination of long and short duration measurements.

The relative error of frequency measurement can be expressed by the formula:

$$\frac{Δ f}{f} = \frac{1}{\sqrt{t \cdot f}}$$

Where f=measurement frequency and t=measurement time.

For the battery powered device, this inverse square root relationship shows that in order to minimize measurement time and, hence, power consumption while maintaining acceptable measurement accuracy, the signal frequency needs to be maximized. Accordingly, in an embodiment, the AC power frequency is configured to be greater than 100 kHz using a crystal oscillator. As an added benefit, this higher frequency is more immune to electromagnetic interference (EMI) from power lines and demodulated audio signals.

In some embodiments, inductance measurement time and accuracy may vary depending on algorithm and application requirements. For example, if passive sensors 302-303 signal high probability of the presence of a vehicle, initially quicker and less accurate measurement may be sufficient to validate the vehicle presence. If no vehicle is present, there will be no signal from the passive sensor that meets a given threshold. If the shorter measurement does not provide enough validation, a longer and more accurate measurement can follow. In other embodiments and applications like car counting, higher frequency and shorter measurements provide higher definition data on a moving object profile.

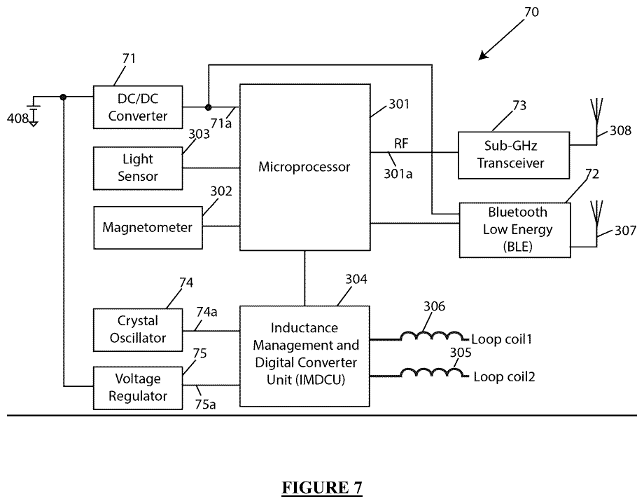

FIG. 7 is a block diagram 70 of a battery-powered wireless vehicle-detection device, according to an embodiment of the present invention. DC/DC converter 71 accepts power from battery 408 and delivers precision power 71a to Microprocessor 301 and to Bluetooth Low Energy (BLE), block 72, which is configured to radiate electromagnetic energy using antenna 307. Voltage regulator 73 delivers precision power 73a to IMDCU 304; this power is activated by microprocessor only when IMDCU 304 is to be activated. IMDCU 304 receives inputs from loop coil1 306, which is of a smaller relative size, and loop coil2 305, which is of a larger relative size. As previously described, microprocessor 301 accepts interrupts from light sensor 303 and magnetometer 302 and applies a detection algorithm. If a vehicle probability is above a certain threshold, IMDCU 304 is activated. After digital inputs from IMDCU 304 are analyzed by microprocessor 301, IMDCU 304 is turned off as previously described. Voltage regulator 75 is turned on by microprocessor 301 only when power is to be delivered to IMDCU 304. For communications with a backend server, microprocessor 310 generates RF signal 301a which is input to sub-GHz transceiver 73, to which antenna 308 is attached.

Crystal oscillator 74 provides a stable and accurate external clock frequency. Its stability enables IMDCU 304 to provide consistent and reliable measurements, even during temperature excursions. In an embodiment, crystal oscillator 74 has a frequency in the range of 100 kHz-50 MHz, and a stability of around 50 ppm in the temperature range of −40 C to +85 C.

Communication by the vehicle detection device with a remote device may comprise Bluetooth communications or long range wireless communications.

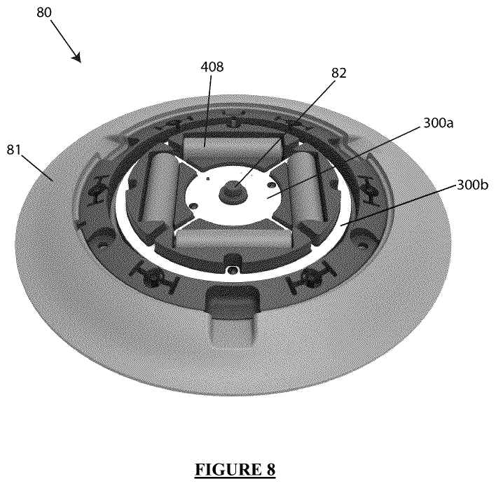

FIG. 8 illustrates components of an exemplary vehicle detection device 80 having a casing 81, a central pillar, 82, batteries 408, and printed circuit board 300a, 300b, in an embodiment of the present disclosure. Portion 300b of the printed circuit board includes loop coil 305 which may have a diameter of at least 4 cm and a preferred diameter of around four inches for example. Batteries 408 are embedded in cut-outs of printer circuit board 300, as described in reference to FIG. 5.

All examples and conditional language recited herein are intended for pedagogical purposes to aid the reader in understanding the principles of the present disclosure and the concepts contributed by the inventor to furthering the art and are to be construed as being without limitation to such specifically recited examples and conditions. Moreover, all statements herein reciting principles, aspects, and embodiments of the present disclosure, as well as specific examples thereof, are intended to encompass both structural and functional equivalents thereof. Additionally, it is intended that such equivalents include both currently known equivalents as well as equivalents developed in the future, e.g., any elements developed that perform the same function, regardless of structure.

1. In some embodiments, a device comprises a battery that generates a first power, and an inductive sensor comprising a loop coil positioned at an outer perimeter of the device that generates a magnetic field based on the first power, and generates, based on a change to the magnetic field, a sensing signal indicating a presence of an object, wherein delivery of the first power to the inductive sensor loop coil is based on one or more additional signals and wherein the frequency of the sensing signal applied to the inductive sensor is in the range of 100 kHz-50 MHz.

2. The device of clause 1 wherein a crystal oscillator provides the frequency of the sensing signal.

3. The device of clauses 1 or 2, wherein data from the passive sensor is sampled at intervals varying between one second and one minute, and wherein an inductive sensor may be turned on for varying durations based on temperature measurements.

4. The device of any of clauses 1-3, further comprising a microprocessor that generates a determination regarding the presence or absence of a vehicle based on the sensing signal, and causes the determination to be wirelessly transmitted to at least one remote device.

5. The device of any of clauses 1-4, further comprising a printed circuit board, wherein the microprocessor is mounted on the printed circuit board, and the batteries are disposed within one or more cut-out areas included in the printed circuit board.

6. The device of any of clauses 1-5, further comprising at least one passive sensor that generates the one or more additional signals, and a microprocessor that receives the one or more additional signals from the at least one passive sensor, and controls, based on the one or more additional signals, the first power to the inductive sensor loop coil.

7. The device of any of clauses 1-6, wherein the least one passive sensor comprises at least one of a light sensor that measures ambient light, and a magnetometer that measures a quantity of ferrous materials, or a temperature sensor.

8. The device of any of clauses 1-7, further comprising a microprocessor that controls delivery of the first power to the inductive sensor loop coil by determining that the one or more additional signals indicate a likelihood that a vehicle is proximate to at least one passive sensor, wherein the at least one passive sensor generates the one or more additional signals, and in response to the determination, causing the battery to provide the first power to the inductive sensor loop coil.

9. The device of any of clauses 1-8, wherein the inductive sensor further comprises an oscillator that (i) converts the first power into a first alternating current (AC) power, and (ii) provides the first AC power to the loop coil, and an analog-to-digital (A/D) converter that (i) receives the sensing signal from the loop coil, and (ii) converts the sensing signal into a digital sensing signal.

10. The device of any of clauses 1-9, further comprising a casing that includes the loop coil, wherein the loop coil (i) is located proximate to an outer perimeter of the casing, or (ii) has a diameter of at least 4 cm.

11. The device of any of clauses 1-10, further comprising a timer that generates a timing signal indicating when a first period ends, and a microprocessor that receives the timing signal, and causes the battery to provide a first power to the inductive sensor loop coil based on (i) the timing signal, or (ii) the one or more additional signals.

12. The device of any of clauses 1-11, further comprising a second inductive sensor loop coil, wherein the inductive sensor loop coil includes a first loop coil having a first loop size and one or more turns, and the second inductive sensor loop coil includes a second loop coil having a second loop size and one or more turns.

13. The device of any of clauses 1-12, wherein a first sensing range of the first loop coil to detect the presence of the object is based on the first loop size, and a second sensing range of the second loop coil to detect the presence of the object is based on the second loop size.

14. The device of any of clauses 1-13, wherein the first sensing range is at least 12 cm.

15. In some embodiments, a method comprises receiving, by an inductive sensor loop coil positioned at an outer perimeter of a device, a first power generated by a battery, wherein the first power is provided to the inductive sensor loop coil based on one or more additional signals, generating, by the inductive sensor loop coil and based on the first power, a magnetic field, generating, based on a change to the magnetic field, a sensing signal indicating a presence of an object, wherein the frequency of the sensing signal applied to the inductive sensor is in the range of 100 kHz-50 MHz.

16. The method of clause 15, further comprising receiving, by a microprocessor, the one or more additional signals that are provided by at least one passive sensor, and providing, based on the one or more additional signals, the first power to the inductive sensor loop coil.

17. The method of clauses 15 or 16, further comprising determining, based on the one or more additional signals, a probability that the object is present, upon determining the probability, providing the first power to the inductive sensor loop coil, wherein the inductive sensor loop coil provides the sensing signal.

18. The method of any of clauses 15-17, further comprising receiving a timing signal indicating when a first period ends, and causes the battery to provide the first power to the inductive sensor loop coil based on (i) the timing signal, or (ii) the one or more additional signals.

19. The method of any of clauses 15-18, further comprising converting the first power into a first alternating current (AC) power, providing the first AC power to a loop coil that generates the magnetic field, receiving, by an analog-to-digital converter, the sensing signal from loop coil, and converting, by the analog-to-digital converter, the sensing signal to a digital sensing signal.

20. The method of any of clauses 15-19, further comprising generating a determination signal based on the sensing signal, and wirelessly transmitting the determination signal to at least one remote device.

21. The method of any of clauses 15-20, wherein the remote device comprises at least one of a portable device, a vehicle counting system, an automatic gate control system, or a remote server.

Any and all combinations of any of the claim elements recited in any of the claims and/or any elements described in this application, in any fashion, fall within the contemplated scope of the present invention and protection.

All examples and conditional language recited herein are intended for pedagogical purposes to aid the reader in understanding the principles of the present disclosure and the concepts contributed by the inventor to furthering the art and are to be construed as being without limitation to such specifically recited examples and conditions. Moreover, all statements herein reciting principles, aspects, and embodiments of the present disclosure, as well as specific examples thereof, are intended to encompass both structural and functional equivalents thereof. Additionally, it is intended that such equivalents include both currently known equivalents as well as equivalents developed in the future, e.g., any elements developed that perform the same function, regardless of structure.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The foregoing descriptions of various specific embodiments in accordance with the present disclosure have been presented for purposes of illustration and description. They are not intended to be exhaustive or to limit the present disclosure to the precise forms disclosed, and many modifications and variations are possible in light of the above teaching. The present disclosure is to be construed according to the claims that follow and their equivalents.

What is claimed is:

1. A device comprising:
a battery that generates a first power; and
an inductive sensor comprising a loop coil positioned at an outer perimeter of the device that generates a magnetic field based on the first power, and generates, based on a change to the magnetic field, a sensing signal indicating a presence of an object;
wherein delivery of the first power to the inductive sensor loop coil is based on one or more additional signals and wherein the frequency of the sensing signal applied to the loop coil is in the range of 100 kHz-50 MHz.

2. The device of claim 1 wherein a crystal oscillator provides the clock frequency for the sensing signal.

3. The device of claim 1 further comprising:
a passive sensor, wherein data from the passive sensor is sampled at intervals varying between one hundred milliseconds and twenty seconds; and
wherein an inductive sensor may be turned on for varying durations based on passive sensor measurements.

4. The device of claim 1, further comprising a microprocessor that:
generates a determination regarding the presence or absence of a vehicle based on the sensing signal; and
causes the determination to be wirelessly transmitted to at least one remote device.

5. The device of claim 4, further comprising a printed circuit board, wherein:
the microprocessor is mounted on the printed circuit board; and
one or more batteries are disposed within one or more cut-out areas included in the printed circuit board.

6. The device of claim 1, further comprising:
at least one passive sensor that generates the one or more additional signals; and
a microprocessor that:
receives the one or more additional signals from the at least one passive sensor; and
controls, based on the one or more additional signals, the first power to the inductive sensor loop coil.

7. The device of claim 6, wherein the least one passive sensor comprises at least one of:
a light sensor that measures ambient light; and
a magnetometer responsive to the proximity of ferrous materials, or a temperature sensor.

8. The device of claim 1, further comprising a microprocessor that controls delivery of the first power to the inductive sensor loop coil by:
determining that the one or more additional signals indicate a likelihood that a vehicle is proximate to at least one passive sensor, wherein the at least one passive sensor generates the one or more additional signals; and
in response to the determination, causing the battery to provide the first power to the inductive sensor loop coil.

9. The device of claim 1, wherein the inductive sensor further comprises:
an oscillator that (i) converts the first power into a first alternating current (AC) power, and (ii) provides the first AC power as a clock frequency for the loop coil; and
an analog-to-digital (A/D) converter that (i) receives the sensing signal from the loop coil, and (ii) converts the sensing signal into a digital sensing signal.

10. The device of claim 1, further comprising a casing that includes the loop coil, wherein the loop coil: (i) is located proximate to an outer perimeter of the casing, or (ii) has a diameter of at least 4 cm.

11. The device of claim 1, further comprising:
a timer that generates a timing signal indicating when a first period ends; and a microprocessor that:
receives the timing signal; and
causes the battery to provide a first power to the inductive sensor loop coil based on (i) the timing signal, or (ii) the one or more additional signals.

12. The device of claim 1, further comprising a second inductive sensor loop coil, wherein:
the inductive sensor loop coil includes a first loop coil having a first loop size and one or more turns; and
the second inductive sensor loop coil includes a second loop coil having a second loop size and one or more turns.

13. The device of claim 12, wherein:
a first sensing range of the first loop coil to detect the presence of the object is based on the first loop size; and
a second sensing range of the second loop coil to detect the presence of the object is based on the second loop size.

14. The device of claim 13, wherein the first sensing range is at least 12 cm.

15. A method comprising:
receiving, by an inductive sensor loop coil positioned at an outer perimeter of a device, a first power generated by a battery, wherein the first power is provided to the inductive sensor loop coil based on one or more additional signals;
generating, by the inductive sensor loop coil and based on the first power, a magnetic field;
generating, based on a change to the magnetic field, a sensing signal indicating a presence of an object, wherein the frequency of the sensing signal applied to the loop coil is in the range of 100 kHz-50 MHz.

16. The method of claim 15, further comprising:
receiving, by a microprocessor, the one or more additional signals that are provided by at least one passive sensor; and
providing, based on the one or more additional signals, the first power to the inductive sensor loop coil.

17. The method of claim 15, further comprising:
determining, based on the one or more additional signals, whether predetermined criteria indicative of the object's presence are satisfied; and;
upon determining that predetermined criteria are satisfied, providing the first power to the inductive sensor loop coil, wherein the inductive sensor loop coil provides the sensing signal.

18. The method of claim 15, further comprising:
receiving a timing signal indicating when a first period ends; and
causes the battery to provide the first power to the inductive sensor loop coil based on (i) the timing signal, or (ii) the one or more additional signals.

19. The method of claim 15, further comprising:
converting the first power into a first alternating current (AC) power; providing the first AC power to a loop coil that generates the magnetic field;
receiving, by an analog-to-digital converter, the sensing signal from loop coil; and
converting, by the analog-to-digital converter, the sensing signal to a digital sensing signal.

20. The method of claim 15, further comprising:
generating a determination signal based on the sensing signal; and wirelessly transmitting the determination signal to at least one remote device.

21. The method of claim 20, wherein the remote device comprises at least one of a portable device, a vehicle counting system, an automatic gate control system, or a remote server.
